(19) United States
(12) Patent Application Publication
(10) Pub. No.: US 2003/0129493 A1
(43) Pub. Date: Jul. 10, 2003

(54) NEGATIVE ELECTRODE ACTIVE MATERIAL FOR USE IN ALKALINE CELL AND METHOD OF PREPARING THE SAME

(75) Inventor: TOSHIYA KITAMURA, AKITA-SHI (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Dowa Mining Co., Tokyo (JP)

(21) Appl. No.: 09/413,984

(22) Filed: Oct. 7, 1999

(30) Foreign Application Priority Data
Oct. 7, 1998 (JP) 285735/1998

(51) Int. Cl. H01M 4/42; H01M 4/62

(52) U.S. Cl. 429/229; 252/182.1; 429/232

(57) ABSTRACT

A negative electrode active material for use in an alkaline cell which is superior to and lower in hydrogen gas generation than a conventional negative electrode active material obtained by alloying zinc to control the gas generation from zinc to be brought about when it contacts an electrolytic solution and a method of preparing the same. Characteristics of conventional alloyed zinc powders for use in a cell can easily be improved into those of powders suitable for use in the cell which are low in hydrogen gas generation by mixing powders of a trivalent metal, for example, Bi or In, to the conventional alloyed zinc powders for use in the cell, preferably by in a range of 50 to 1000 ppm, under a dry condition.

### BACKGROUND OF THE INVENTION

The present invention relates to negative electrode active materials for use in alkaline cells and, more particularly, to a negative electrode active material for use in a cell which is low in gas generation and which is prepared by mixing a metal whose valence number of trivalence as its oxide is chemically stable at room temperature and atmospheric pressure with an alloyed zinc powder including zinc as a main component, and a method of preparing the same. The term “a metal whose valence number of trivalence as its oxide is chemically stable at room temperature and atmospheric pressure” herein used means a metal whose trivalent compound such as an oxide thereof is chemically stable at room temperature and atmospheric pressure.

Zinc has been favorably used as a negative electrode active material since it has an appropriate potential when used as a negative electrode for a cell in an aqueous solution system, as well as it is low-priced. However, its corrosion potential is more base than the decomposition potential of water so that, when it contacts an electrolytic solution, zinc corrosion and decomposition of water occur to generate a hydrogen gas. Such hydrogen gas generation not only reduces cell capacity of zinc as a negative electrode material, but also, when used in a closed-type cell, increases an inner pressure of the cell to bring about leakage of the electrolytic solution therefrom and, in a worst case, burst of the cell.

Heretofore hydrogen generation has been controlled by alloying zinc, surface treatment of zinc particles, adopting a suitable composition of electrolytic solution and addition of a corrosion inhibitor to the electrolytic solution. In other words, at alloying zinc, a zinc alloy including some components selected from the group consisting of Al, Bi, In, Ga, Sn, Pb and the like has primarily been used in a manner that a composition ratio of these elements is optimized relative to gas generation. However, it is a present situation that such optimization ratio is not enough to solve the problems.

Moreover, although a method of adding an indium compound such as indium oxide, indium hydroxide or the like, or a bismuth compound such as bismuth oxide, bismuth hydroxide or the like to an electrolyte gel has been proposed, this method is hardly expected to provide a stable effect and, in addition, it necessitates to mix a zinc powder and an additive in the electrolyte gel at the same time whereupon mixing work of solid and liquid is troublesome.

### SUMMARY OF THE INVENTION

As described above, alloying zinc and other methods have been performed so as to control hydrogen gas generation; however, it is hard to say that any of them can obtain a fully stable effect. Accordingly, the object of the present invention is to provide a negative electrode active material for use in a cell which will reduce hydrogen gas generation from zinc to be brought about when it contacts an electrolytic solution and a method of producing the same.

The present inventor has conducted intensive studies in order to solve the aforementioned problems of the prior art and has found that the addition of a metal having trivalence to an alloyed zinc powder by the dry mixing method, in more particularly, the addition of a metallic powder of either Bi or In to the conventional alloyed zinc powder for use in a cell by the dry mixing method, preferably in a range of 50-1000 (ppm) based on the weight of the alloyed zinc powder, can substantially improve the characteristics of the mixed product which is a powder for use in a cell showing low hydrogen gas generation; hence, the present invention has been accomplished on the basis of this finding.

In accordance with one aspect of the present invention, there is provided a negative electrode active material for use in an alkaline cell comprising a composition composed by mixing a metal whose valence number of trivalence is chemically stable as an oxide thereof at room temperature and atmospheric pressure with a zinc alloy powder for use in a cell.

In accordance with another aspect of the present invention, there is provided a negative electrode active material for use in an alkaline cell comprising a composition composed by mixing a metal whose valence number of trivalence as an oxide thereof is chemically stable at room temperature and atmospheric pressure with a zinc alloy powder for use in a cell by 50 to 1000 ppm based on the weight of the zinc alloy powder for use in the cell.

In accordance with another aspect of the present invention, there is provided the negative electrode active material for use in the alkaline cell as described above, in which the metal whose valence number of trivalence as the oxide thereof is chemically stable at the aforementioned room temperature and the aforementioned atmospheric pressure is Bi or In.

In accordance with another aspect of the present invention, there is provided the negative electrode active material for use in the alkaline cell as described above, in which the metal is a metallic powder with an average particle size of 100 μm or less.

In accordance with another aspect of the present invention, there is provided a negative electrode active material for use in an alkaline cell of low gas generation comprising mixing the metallic powder to a zinc alloy powder for use in a cell under a dry condition.

In accordance with another aspect of the present invention, there is provided a method of preparing a negative electrode active material for use in an alkaline cell comprising a composition composed by mixing a metal whose valence number of trivalence is chemically stable as an oxide thereof at room temperature and atmospheric pressure to a zinc alloy powder for use in a cell.

In accordance with another aspect of the present invention, there is provided a method of preparing a negative electrode active material for use in an alkaline cell comprising the step of mixing a metal whose valence number of trivalence as an oxide thereof is chemically stable at room temperature and atmospheric pressure to a zinc alloy powder for use in a cell by 50 to 1000 ppm based on the weight of the zinc alloy powder for use in the cell.

In accordance with another aspect of the present invention, there is provided the method of preparing the negative electrode active material for use in the alkaline cell as described above, in which the metal whose valence number of trivalence as the oxide thereof is chemically stable at the aforementioned room temperature and under the aforementioned atmospheric pressure is Bi or In.

In accordance with another aspect of the present invention, there is provided the method of preparing the negative electrode active material for use in the alkaline cell as described above, in which the aforementioned metal is a metallic powder with an average particle size of 100 μm or less.

In accordance with another aspect of the present invention, there is provided a method of preparing a negative electrode active material for use in an alkaline cell of low gas generation comprising the step of mixing the aforementioned metallic powder to a zinc alloy powder for use in a cell under a dry condition.

### BRIEF DESCRIPTION OF THE DRAWINGS

FIG. 1 is a graph in an embodiment of the present invention showing a relationship between the amount of metallic Bi powder added to the alloyed zinc powder and gas generation amounts; and

FIG. 2 is a graph in an embodiment of the present invention showing a relationship between the amount of metallic In powder and the gas generation amount.

### DETAILED DESCRIPTION OF THE INVENTION

The trivalent metal-mixed zinc powder according to the present invention can easily be prepared by mixing a trivalent metal powder (with a particle size of under 100 μm) such as a powder of Bi, In or the like with a conventional alloyed zinc powder under a dry condition. The product thus obtained is readily available as a zinc powder for use in a cell which is low in hydrogen gas generation.

In other words, by mixing of these metallic powders, a negative electrode active material with extremely low hydrogen gas generation which has never been achieved by the alloying method can be obtained. Moreover, by employing the thus prepared trivalent metal-mixed zinc powder as a negative electrode material for use in an alkaline cell, an alkaline cell which is excellent in preservability, storability and safety can be provided.

Mechanism of controlling hydrogen gas generation by mixing the trivalent metallic powders to the zinc powders has not been resolved, but is considered to be as follows:

Generally, the reaction of hydrogen gas generation is considered as follows:

Zn+2H₂O+2OH⁻=Zn(OH)₄²⁻+H₂↑ (1)

Zn(OH)₄²⁻ ion produced in the above formula (1) undergoes further reaction with an increase in its concentration as follows:

Zn(OH)₄²⁻→Zn(OH)₂→ZnO

Namely,

Zn(OH)₄²⁻→Zn(OH)₂+2OH⁻ (2)

Zn(OH)₂→ZnO+H₂O (3)

The thus produced coating has a construction of Zn/ZnO/Zn(OH)₂/Zn(OH)₄²⁻ in order from the side of electrolytic solution toward the side of zinc.

Since a Zn(OH)₂ coating is of a porous sediment, ZnO basically plays an important role as an anti-corrosive coating. In fact, it is considered that a very thin ZnO coating is formed when zinc contacts the electrolytic solution and, accordingly, a gas generation reaction shown in formula (1) advances by the reaction of Zn which has moved through the ZnO coating to the surface of the electrolytic solution even if zinc is not exposed to the electrolytic solution at a possible crack in the coating.

ZnO is a nonstoichiometric compound of excess Zn type illustrated by Zn_{i+δ}O in which excess amount of Zn exists as interstitial ions.

The more the amount of interstitial ions, the more the amount of Zn which moves through the ZnO coating to the surface of electrolytic solution and, accordingly, the higher the gas generation shown in formula (1).

An interstitial zinc ion, i.e., Znᵢ., is formed by a reaction shown in the following formula:

ZnO=Znᵢ.+e⁻+½0₂ (4)

in which equilibrium constant (K) is shown as follows:

K=[Znᵢ.].[e⁻].P₀₂^{1/2} (5)

It is considered that P₀₂ is constant in this case so that formula (5) can be restated as follows:

Ki′=[Znᵢ.].[e⁻]

If a portion of Zn site of ZnO is substituted with a trivalent ion, i.e., M³⁺, at this point, following formula can be obtained:

M₂O₃=2M_{Zn}.+2e⁻+2O₀+½0₂ (7)

Since electrons, i.e., e⁻, are supplied according to formula (7), the reaction shown in formula (4) advances leftward whereupon the amount of interstitial Zn ions, namely, Znᵢ., is decreased. Ion species which moves in the coating is this interstitial Zn ion, Znᵢ., so that the decrease of the amount of Znᵢ. leads to the decrease of the amount of Zn which moves up to the surface of the electrolytic solution thereby resulting in controlling zinc corrosion reaction (which is equal to hydrogen gas generation reaction) shown in formula (1).

Bi and In shown in the present invention become respective trivalent oxides or ions in a high-alkaline electrolytic solution in accordance with the following reactions and then the thus produced ionized chemical species of these dissolve in the ZnO coating to make respective solid solutions through substitutions (reference: M. Pourbaix: “Atlas of Electrochemical Equilibria in Aqueous Solutions” NACE (1974)):

2Bi+6OH⁻=Bi₂O₃+3H₂O+6e⁻ (8)

3In+6OH⁻=In₂O₃+3H₂O+6e⁻ (9)

Bi+4OH⁻=BiO₂⁻+2H₂O+4e⁻ (8)′

In+4OH⁻=InO₂⁻+2H₂O+4e⁻ (9)′

Since electrons, e⁻, are supplied according to formula (7), electrical conductivity of an oxidized coating is increased.

When trivalent ions of metals such as Bi, In and the like are taken into the ZnO coating during the ZnO forming step in which the electrolytic solution and zinc contact each other, hydrogen gas generation will be reduced to increase electrical conductivity of the coating.

In order to produce a Bi or In solid solution effectively in the ZnO forming step, it is necessary for a suitable amount of the powder of one of these metals to be effectively dispersed on the surfaces of zinc particles.

To attain this, it is necessary for an average particle size of the mixed metal to be 100 μm or less and, moreover, its addition is preferably within a range of 50 to 1000 (ppm) based on the weight of zinc alloy powder for use in a cell. If the addition is less than 50 ppm, an effect to be brought about by the addition will not appear. Whereas if the addition is over 1000 ppm, cell capacity will decrease, as well as an effect to be brought about by the addition increment will not appear.

Examples and Comparative Examples are provided below for the purpose of further illustrating the present invention, but are in no way to be taken as limiting it and also the alloyed zinc powder composition and the mixed metal powders according to the present invention are by no means limited to being employed in the illustrated Examples and Comparative Examples. Unless otherwise stated, all parts and percentages are herein given by weight.

### COMPARATIVE EXAMPLE 1

Alloyed zinc powders with a composition composed of Bi of 89 ppm, Al of 31.1 ppm, In of 516 and the rest of Zn and with particle sizes of 75 to 850 μm were prepared by the atomizing method.

A 40% KOH electrolytic solution saturated with zinc oxide was added to the thus prepared alloyed zinc powders and kept at 60° C. On the basis of gas generation of the third day, a gas generation amount was calculated (in a unit of μl/g·day). Gas generation measurements have been performed on five pieces of the above-prepared sample. As a result, an average of 18.32 (μl/g·day) and a standard deviation of 1.586 (μl/g·day) were obtained.

### EXAMPLE 1

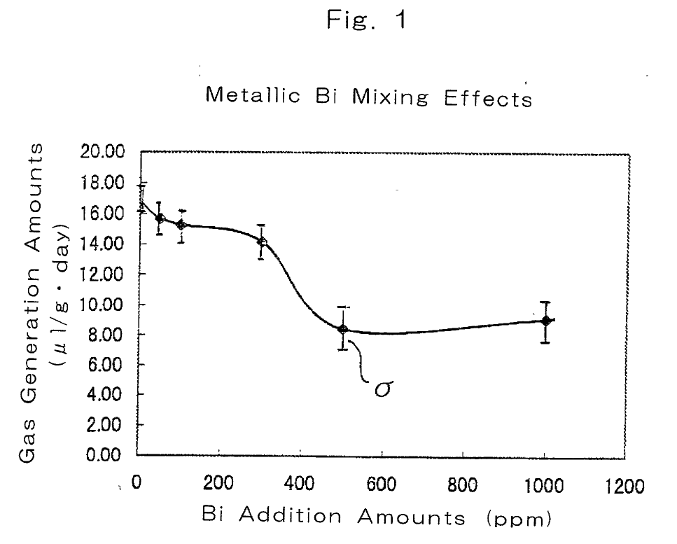

50 ppm, 100 ppm, 300 ppm, 500 ppm and 1000 ppm of the bismuth powder available from Saitama Dowa High-Tech Co. was respectively mixed, based on the weight of the alloyed zinc powder described in Comparative Example 1, with the alloyed zinc powder described in Comparative Example 1 to prepare samples (No. 1 to No. 5) which were then put on the gas generation tests in the same way as in Comparative Example 1. Test results are shown in Table 1. The results are also shown in a graph in FIG. 1.

From the test results, it has been confirmed that mixing of metallic bismuth is effective in controlling gas generation and, particularly, a mixing amount of 500 (ppm) or more is effective for decreasing the gas generation.

TABLE 1
(μl/g · day)

| | Addition Amounts of Metallic Bi Powder (ppm) | | | | |
|---|---|---|---|---|---|
| | 50 | 100 | 300 | 500 | 1000 |
| No. 1 | 16.52 | 16.34 | 14.61 | 9.99 | 10.31 |
| No. 2 | 14.37 | 14.80 | 14.49 | 7.73 | 4.67 |
| No. 3 | 17.53 | 15.81 | 14.73 | 8.21 | 8.90 |
| No. 4 | 15.38 | 15.02 | 15.90 | 9.34 | 11.94 |
| No. 5 | 14.50 | 14.3 | 11.07 | 6.93 | 9.77 |
| Average | 15.66 | 15.25 | 14.16 | 8.44 | 9.12 |
| Standard Deviation | 1.353 | 0.815 | 1.817 | 1.230 | 2.722 |

### COMPARATIVE EXAMPLE 2

Alloyed zinc powder with a composition composed of Bi of 89 ppm, Al of 32.8 ppm, In of 520 and the rest of Zn and with a particle size in the range of 75 to 850 μm was prepared by the atomizing method.

A 40% KOH electrolytic solution saturated with zinc oxide was added to the thus prepared alloyed zinc powder and kept at 60° C. On the basis of gas generation of the third day, a gas generation amount was calculated (in a unit of μl/g·day). Gas generation measurements have been performed on five pieces of the above-prepared sample in the same way as in Comparative Example 1. As a result, an average of 23.53 (μl/g·day) and a standard deviation of 1.682 (μl/g·day) were obtained.

### EXAMPLE 2

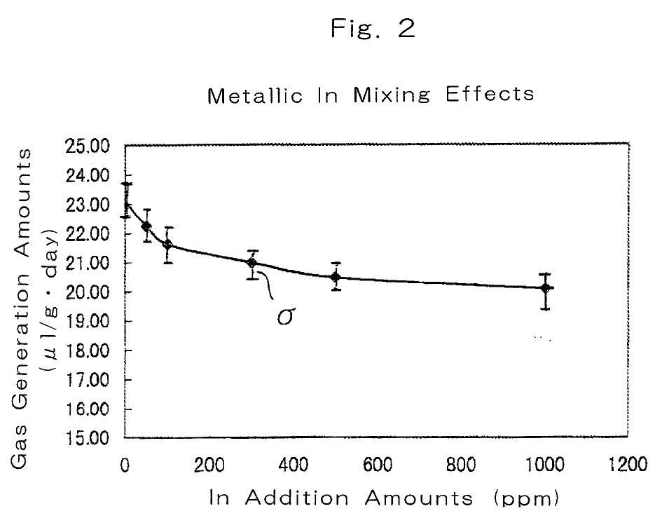

50 ppm, 100 ppm, 300 ppm, 500 ppm and 1000 ppm each of metallic indium (with purity of 99% or more and particle sizes of less than 100 μm) available from Kojundo Kagaku Kenkyusho was mixed, based on the weight of the alloyed zinc powder described in Comparative Example 2, with the alloyed zinc powders described in Comparative Example 2 to prepare respective samples (No.1 to No.5) which were then subjected to the gas generation tests in the same way as in Comparative Example 2. Test results are shown in Table 2. The results are also shown in a graph in FIG. 2.

From the test results, it has been confirmed that mixing of metallic indium is effective in controlling gas generation since the gas generation was gradually decreased with an increase of metallic indium mixing in each sample.

TABLE 2
(μl/g · day)

| | Addition Amounts of Metallic In Powder (ppm) | | | | |
|---|---|---|---|---|---|
| | 50 | 100 | 300 | 500 | 1000 |
| No. 1 | 22.67 | 20.00 | 22.67 | 19.33 | 21.33 |
| No. 2 | 22.00 | 22.67 | 21.33 | 22.87 | 18.82 |
| No. 3 | 22.00 | 22.72 | 18.00 | 20.00 | 20.33 |
| No. 4 | 22.00 | 22.67 | 23.33 | 20.09 | 20.67 |
| No. 5 | 22.45 | 20.01 | 19.45 | 20.03 | 19.21 |
| Average | 22.22 | 21.61 | 20.96 | 20.46 | 20.07 |
| Standard Deviation | 0.335 | 1.344 | 2.372 | 1.569 | 1.063 |

As has been described above, the negative electrode active material for use in the alkaline cell according to the present invention is easily obtained by mixing a powder of trivalent metal such as Bi, In or the like with the conventional alloyed zinc powder under a dry condition. The product thus obtained is a zinc powder for use in the cell which shows low hydrogen gas generation, having attained reduction of gas generation to such an extent that it has never been attained by the conventional alloying method and, moreover, the powder is capable of providing an alkaline cell which is excellent in preservability, storability and safety.

What is claimed is:

1. A negative electrode active material for use in an alkaline cell characterized by comprising a mixture of a zinc alloy powder for use in a cell and an additional metal, wherein said additional metal is a metal whose trivalent compound is chemically stable at room temperature and atmospheric pressure.

2. A negative electrode active material for use in an alkaline cell characterized by comprising a mixture of a zinc alloy powder for use in a cell and an additional metal incorporated therein in an amount of 50-1000 ppm by weight based on the amount of said zinc alloy powder for use in a cell, said additional metal being a metal whose trivalent compound is chemically stable at room temperature and atmospheric pressure.

3. The negative electrode active material for use in an alkaline cell according to claim 1 or 2, wherein said additional metal is Bi or In.

4. The negative electrode active material for use in an alkaline cell according to claim 1 or 2, wherein said additional metal is a metallic powder with an average particle size of 100 μm or less.

5. The negative electrode active material for use in an alkaline cell according to claim 3, wherein said additional metal is a metallic powder with an average particle size of 100 μm or less.

6. A negative electrode active material for use in an alkaline cell of low gas generation comprising a mixture of a metallic powder and a zinc alloy powder for use in a cell, said mixture being prepared by dry mixing said metallic powder and said zinc alloy powder, the metal of said metallic powder being one whose trivalent compound is chemically stable at room temperature and atmospheric pressure.

7. A method of preparing a negative electrode active material for use in an alkaline cell comprising the step of mixing a zinc alloy powder for use in a cell with an additional metal, said additional metal being a metal whose trivalent compound is chemically stable at room temperature and atmospheric pressure.

8. A method of preparing a negative electrode active material for use in an alkaline cell comprising the step of mixing a zinc alloy powder for use in a cell with an additional metal, said additional metal being a metal whose trivalent compound is chemically stable at room temperature and atmospheric pressure, said additional metal being added in an amount of 50 to 1000 ppm by weight based on the weight of the zinc alloy powder for use in a cell.

9. The method of preparing a negative electrode active material for use in an alkaline cell according to claim 7 or 8, wherein said additional metal is Bi or In.

10. The method of preparing a negative electrode active material for use in an alkaline cell according to claim 7 or 8, wherein said additional metal is a metallic powder with an average particle size of 100 μm or less.

11. The method of preparing a negative electrode active material for use in an alkaline cell according to claim 9, wherein said additional metal is a metallic powder with an average particle size of 100 μm or less.

12. A method of preparing a negative electrode active material for use in an alkaline cell of low gas generation comprising the step of dry mixing a zinc alloy powder for use in a cell with a powder of an additional metal, said additional metal being a metal whose trivalent compound is chemically stable at room temperature and atmospheric pressure.
